(19) United States
(12) Patent Application Publication
(10) Pub. No.: US 2026/0178710 A1
(43) Pub. Date: Jun. 25, 2026

(54) COLLABORATIVE AUTHORIZATION BASED ON RISK ANALYSIS

(71) Applicant: Dell Products L.P., Round Rock, TX (US)

(72) Inventors: ASHOK NARAYANAN POTTI, Bangalore (IN); TSEHSIN JASON LIU, Wellesley, MA (US); ZIJIA WANG, London (GB); DALE WANG, Hayward, CA (US); MIN GONG, Shanghai (CN)

(21) Appl. No.: 18/989,960

(22) Filed: Dec. 20, 2024

(51) Int. Cl. G06F 21/31; G06F 21/57

(52) U.S. Cl. CPC G06F 21/31; G06F 21/577

(57) ABSTRACT

Methods and systems for managing operation of a deployment of data processing systems are disclosed. The operation may be managed by identifying, by at least one data processing system, a level of risk in servicing a data request for a portion of data maintained by the data processing systems. The level of risk may be based on information regarding an entity that originated the data request and may used to obtain an authorization process. The authorization process may be collaboratively performed by a portion of the data processing systems that may be identified using a similarity map. To do so, a set of authorization mechanisms may be used by each of the portion of data processing systems to obtain an authorization outcome that indicates whether the data request is authorized to be serviced.

### FIELD

Embodiments disclosed herein relate generally to managing operation of a deployment comprising data processing systems. More particularly, embodiments disclosed herein relate to collaboratively authorizing a data request based on a risk analysis.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a diagram illustrating a system in accordance with an embodiment.

FIG. 2A shows a data flow diagram in accordance with an embodiment.

FIGS. 2B-2C show interaction diagrams in accordance with an embodiment.

FIGS. 3A-3B show flow diagrams illustrating methods in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing operation of a deployment comprising data processing systems. The data processing systems may operate in a computing infrastructure that may be managed with and/or without a central processing entity.

While operating, a data processing system may obtain a request for a portion of data maintained by the data processing systems. For example, the data processing system may receive a request to access the portion of data from another data processing system (and/or a user of the other data processing system). To mitigate risk associated with servicing the data request, an authorization process may be collaboratively performed for the data request.

The authorization process may be based, at least in part, on a level of risk in servicing the data request. The level of risk may be identified based, at least in part, on information regarding an entity that originated the data request. For example, the data processing system may identify an internet protocol address, profile of activity of the entity in generating the data request, and/or any other information regarding the entity and/or the data request. Additionally, a level of autonomy may be identified for the data processing system with respect to servicing the data request. The level of the autonomy may include a measure of discretion ascribed to the data processing system in authorizing and/or servicing the data request.

Based on the level of risk and/or the level of autonomy, the data processing system may identify a portion of data processing systems to collaboratively obtain an authorization outcome. The portion of data processing systems may be identified using a similarity map that may provide a view of data processing systems in the deployment. The similarity map may quantity levels of similarity between the data processing systems that may be used to select the portion of data processing systems with which to collaborate.

Furthermore, the data processing system may obtain an authorization process based, at least in part, on the level of risk. For example, a higher quantity of authorization mechanisms may be used for a data request with a higher level of risk. The authorization mechanisms may include, for example, validating credentials of the entity that originated the data request, an attestation for the entity, and/or any other mechanisms.

The data processing system may subsequently issue any number and types of authorization challenges (e.g., prescribed based on the authorization mechanisms) to each of the portion of data processing systems to obtain a plurality of responses. If the responses indicate that the data request is authorized, the data processing system may service the data request to provide access of the requested portion of data to the entity.

Thus, embodiments disclosed herein may provide an improved method for managing operation of a deployment comprising data processing systems. By collaboratively, between a data processing system and a selected portion of other data processing systems, authorizing a data request based on a level of risk, a risk of servicing a data request that may negatively impact computer-implemented services provided by the data processing systems may be mitigated.

In an embodiment, a method for managing operation of a deployment comprising data processing systems is provided. The method may include: (i) obtaining, by a data processing system of the data processing systems, a data request for a portion of data maintained by the data processing systems; (ii) identifying, by the data processing system, a level of risk in servicing the data request based on, at least in part, information regarding an entity that originated the data request; (iii) obtaining, by the data processing system, an authorization process for the data request based, at least in part, on the level of risk; (iv) collaboratively performing, by the data processing system and a portion of the data processing systems, the authorization process to obtain an authorization outcome; (v) in a first instance of the collaborative performing where the authorization outcome indicates that the data request is authorized: (a) servicing, by the data processing system, the data request to facilitate provisioning of desired computer implemented services.

Identifying the level of risk may include: obtaining at least one portion of information from a list of information consisting of: (i) an internet protocol address of the entity; (ii) a geographic location of the entity; (iii) a connection type used to transit the data request to the data processing system; (iv) an origination time of the data request; and (v) a profile of activity of the entity in generating the data request.

Identifying the level of risk may also include: (i) comparing the at least the one portion of the information to historic information regarding previously issued data requests by the entity to identify a level of difference; (ii) establishing the level of risk based on, at least, the level of difference.

Obtaining the authorization process may include: searching a repository of authorization processes using the level of risk as a key to identify the authorization process.

The repository may include a plurality of authorization process that are each keyed to different levels of risk.

Each authorization process of the plurality of authorization processes may specify a minimum set of authorization mechanisms to be used in authorizing of data requests, and the minimum set of authorization mechanisms increase as the level of risk increases.

The authorization mechanisms may include at least one selected from a list of authorization mechanisms consisting of: (i) credentials of a user that originated the data request; (ii) an attestation for the entity; and (iii) a third party verification for the entity.

Collaboratively performing the authorization process may include: (i) identifying the portion of the data processing systems using a similarity map; (ii) issuing a prescribed number and type of authorization challenges to the portion of the data processing systems to obtain a plurality of responses; and obtaining the authorization outcome based on the plurality of responses.

The similarity map may quantity levels of similarity between the data processing systems, and the portion of the data processing systems is discriminated from the data processing systems based on the levels of similarity.

The levels of similarity may be used to rank order the data processing systems, and the portion of the data processing systems may be selected based on the rank ordering of the data processing systems.

Collaboratively performing the authorization process may also include: (i) identifying a level of autonomy for selection of a manner in which to perform the authorization process based on an estimated impact level of the data request.

The level of autonomy may be identified using an autonomy model that vests more decision power in the data processing system as the estimated impact level is reduced and vests less decision power in the data processing system as the estimated impact level is increased.

In an embodiment, a non-transitory media is provided. The non-transitory media may include instructions that when executed by a processor cause the computer-implemented method to be performed.

In an embodiment, a system is provided. The system may include the non-transitory media and a processor, and may perform the computer-implemented method when the computer instructions are executed by the processor.

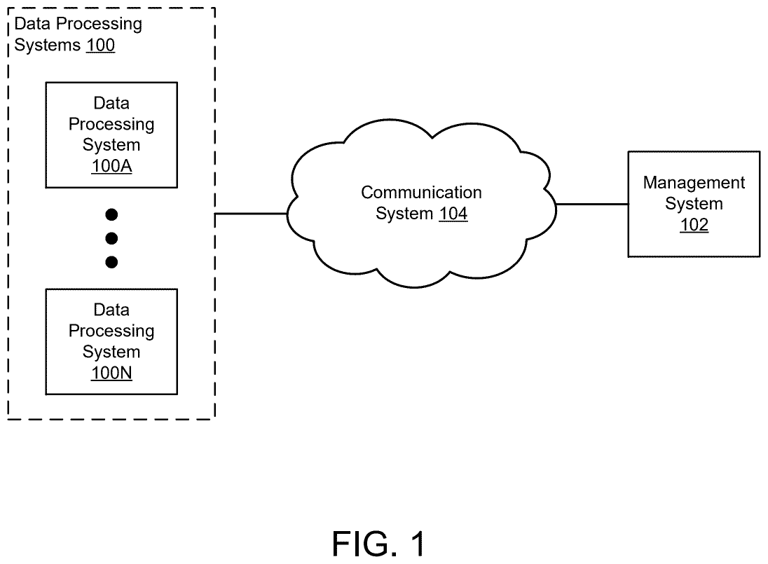

Turning to FIG. 1, a block diagram illustrating a system in accordance with an embodiment is shown. The system shown in FIG. 1 may provide any type and quantity of computer-implemented services (e.g., to user of the system and/or devices operably connected to the system).

The computer-implemented services may include, for example, database services, data processing services, electronic communication services, and/or any other services that may be provided using one or more computing devices. The computer-implemented services may be provided by, for example, data processing systems 100, management system 102, and/or any other type of devices (not shown in FIG. 1). Other types of computer-implemented services may be provided by the system shown in FIG. 1 without departing from embodiments disclosed herein.

The system may include data processing systems 100. Each data processing system (e.g., 100A, 100B, etc.) may provide similar and/or different computer-implemented services, and may provide the computer-implemented services independently and/or in cooperation with other data processing systems. Data processing systems 100 may include edge devices (e.g., located at the edge of a computing infrastructure) that may, for example, generate local data, host various resources, and/or perform any other functionality.

Due to computational limitations of a given data processing system, data (e.g., telemetry data, operational data, etc.) may be generated by each data processing system and provided to a management system that may configured as a centralized processing entity. The management system may, for example, perform data processing, model training, system deployment, inference generation, and/or perform any other actions to manage operation of the data processing systems. Such processing by the management system may be negatively impacted by poor network connectivity, packet losses during transfer, expensive data transmission costs, and/or other such limitations.

Because data processing systems 100 may each host computing resources (e.g., hardware resources, software resources, etc.) capable of providing at least a portion of the computer-implemented services, data processing systems 100 may collaborate (e.g., communicate, share data, etc.) to perform actions relevant to updating operation of data processing systems 100. To do so, a data processing system (e.g., 100A) may obtain a data request for a portion of data maintained by data processing systems 100 from an entity (e.g., a user, a software agent hosted by a different data processing system, etc.) that may request access to the portion of data.

However, data processing systems 100 may be subject to attacks by malicious entities. For example, a malicious entity (e.g., an unauthorized user, malware, etc.) may provide a data request to data processing system 100A of the deployment to access (e.g., read, delete, overwrite, etc.) a portion of data maintained by data processing systems 100. If serviced, the data request from the malicious entity may place data processing system 100A and/or other data processing systems of data processing systems 100 in a potentially compromised state.

To mitigate a risk in servicing a data request, an authorization process may be performed to identify whether the data request may be securely serviced. The authorization process may be based, at least in part, on a level of risk in servicing the data request. The level of risk may be identified using information regarding an entity that originated the data request.

For example, data processing system 100A may identify an internet protocol address, a geographic location of the entity, a connection type used to transit the data request to data processing system 100A, an origination time of the data request, profile of activity of the entity in generating the data request, and/or any other information regarding the entity and/or the data request.

To assess the level of risk, the information may be used, for example, in (i) matching to access policies defined for data maintained by data processing systems 100 (e.g., to identify whether the internet protocol address of the entity is present in a whitelist and/or a blacklist), (ii) comparing at least a portion of the information to historic information regarding previous issued data requests to identify a level of difference, and/or performing any other actions. For example, consider a scenario in which the entity typically sends data requests to data processing system 100A from a certain geographic location and during a window of time between 10:00 AM to 5:00 PM. A data request sent by the entity from a different geographic location and at 2:00 AM may identified to be of a higher level of risk due to a higher level of difference compared to the historic information regarding the typical data requests obtained from the entity.

Additionally, a level of autonomy may be identified for data processing system 100A with respect to servicing the data request. The level of the autonomy may include a measure of discretion ascribed to the data processing system in authorizing and/or servicing the data request.

Once identified, the level of risk and/or the level autonomy may be used to obtain an authorization process. For example, data processing systems 100 may maintain a repository of any number and/or types of authorization processes that may each be keyed to different levels of risk. The repository may be searched using the identified level of risk for the data request to identify the authorization process. The authorization process may specify a minimum set of authorization mechanisms to be used in authorizing the data request and the minimum set of authorization mechanisms may increase as the level of risk increases. For example, a higher quantity of authorization mechanisms may be used for a data request with a higher level of risk. The authorization mechanisms may include, for example, validating credentials of the entity that originated the data request, an attestation for the entity, and/or any other mechanisms.

The authorization process may be collaboratively performed between data processing system 100 and a portion of data processing systems 100. The portion of data processing systems 100 may be identified using a similarity map that may provide a view of data processing systems in the deployment. The similarity map may quantity levels of similarity between the data processing systems that may be used to select the portion of data processing systems with which to collaborate. For example, data processing system 100A may host a copy of the similarity map that ranks the other data processing systems based on similarity of attributes of the other data processing systems compared to attributes of data processing system 100A. Selecting the portion of other data processing systems that is similar and/or dissimilar may enable data processing system 100A to, for example, (i) obtain diverse responses to obtain an authorization outcome, (ii) utilize different resources to perform the authorization process, etc.

Data processing system 100A may subsequently issue any number and types of authorization challenges (e.g., prescribed based on the authorization mechanisms) to each of the portion of data processing systems to obtain a plurality of responses. For example, data processing system 100A may obtain credentials (e.g., username, password, etc.) for each of the portion of data processing systems, vouchers usable to establish trust in a respective data processing system, a dynamic password (e.g., a one-time password) to validate access, and/or any other information required to satisfy an authorization challenge.

In an instance where the responses indicate that the data request is authorized, data processing system 100A may service the data request to provide access of the requested portion of data to the entity. In a second instance where the responses indicate that the data request is not authorized, a risk mediation process may be performed to prevent the data request from being serviced, prevent further communication from the entity, and/or any other processes. By doing so, a risk of servicing a malicious data request may be mitigated while providing desired computer-implemented services.

To provide the above noted functionality, the system may include data processing systems 100, and management system 102. Each of these components is discussed below.

Data processing systems 100 may include any number of data processing systems (e.g., 100A-100N) that may provide at least a portion of the computer-implemented services (e.g., to users of data processing system 100). To do so, each data processing system (e.g., 100A-100N) of data processing systems 100 may host applications and/or computer-implemented models (e.g., large language models, generative artificial intelligence models, etc.) that provide these (and/or other) computer-implemented services. The applications and/or computer-implemented models may be hosted by one or more of data processing systems 100A-100N. For example, the applications may utilize (e.g., invoke use of, etc.) one or more backend components (e.g., the computer-implemented models, policies, backend applications, data and infrastructures, etc.) to provide the computer-implemented services.

A data processing system (e.g., 100A) may obtain data requests from an entity (e.g., another data processing system, a user, etc.) requesting access to a portion of data hosted by data processing systems 100. For example, data processing system 100A may host software that provides an application programming interface to request and/or share data. Data processing system 100A may collect information regarding the entity with respect to the data request to evaluate a level of risk in servicing the data request. Additionally, data processing system 100A may collaborate with any number of other data processing systems (e.g., 100B, 100C, etc.) of data processing systems 100 to further evaluate a risk of servicing the data request and/or authorizing the data request to be serviced. If authorized, data processing system 100A may perform operations (e.g., creation, modification, access, etc.) using the requested portion of data.

Management system 102 may provide management services (e.g., for data processing systems 100). Management system 102 may include another data processing system configured as a centralized processing entity. For example, to provide the management services, management system 102 may be configured to receive data (e.g., telemetry data) from at least a portion of data processing systems 100 in order to manage system health, application and/or other software related deployments, physical deployments, updates, anomaly detection, anomaly analysis, anomaly resolution, and/or other similar services for data processing systems 100.

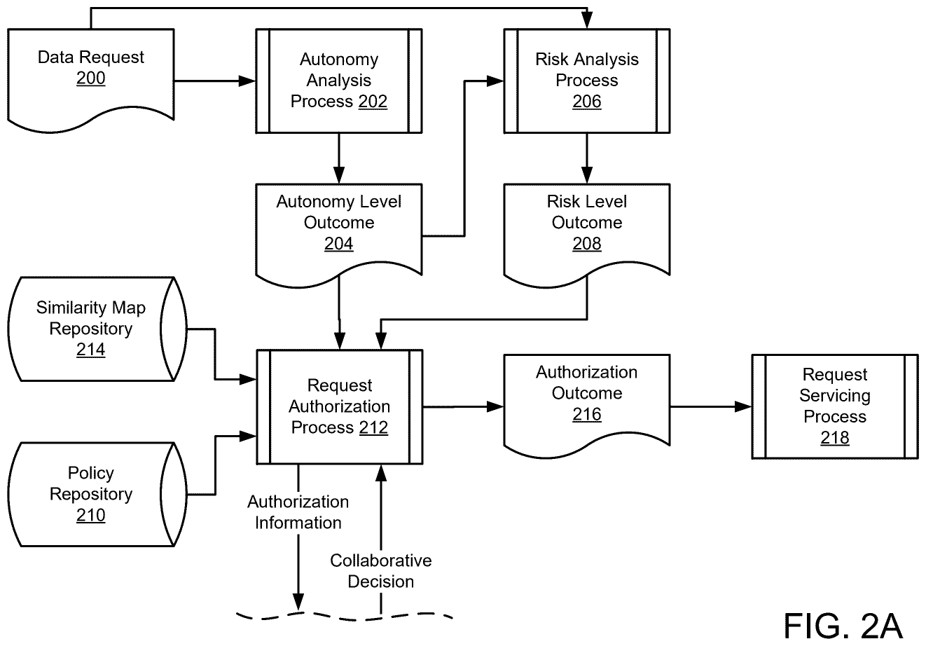

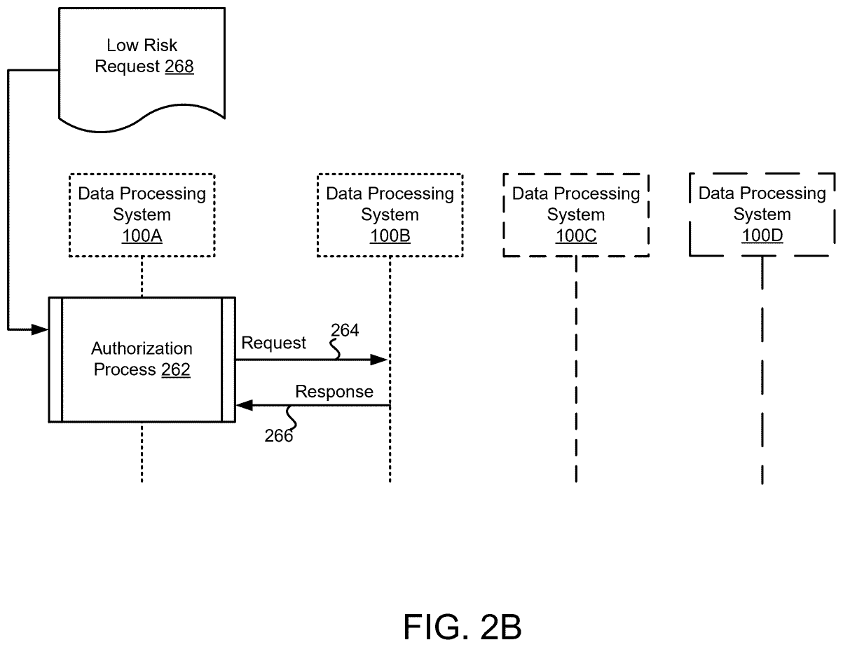

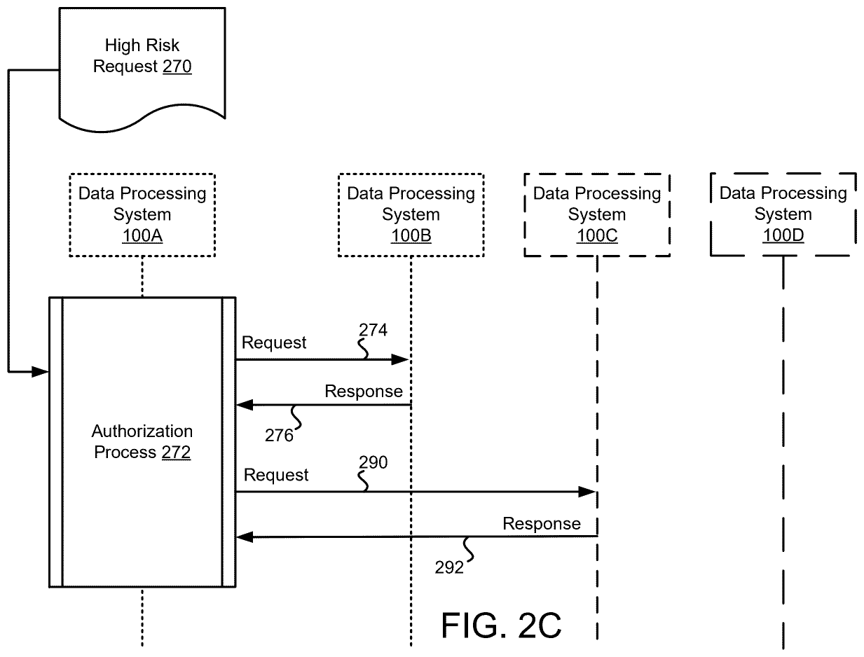

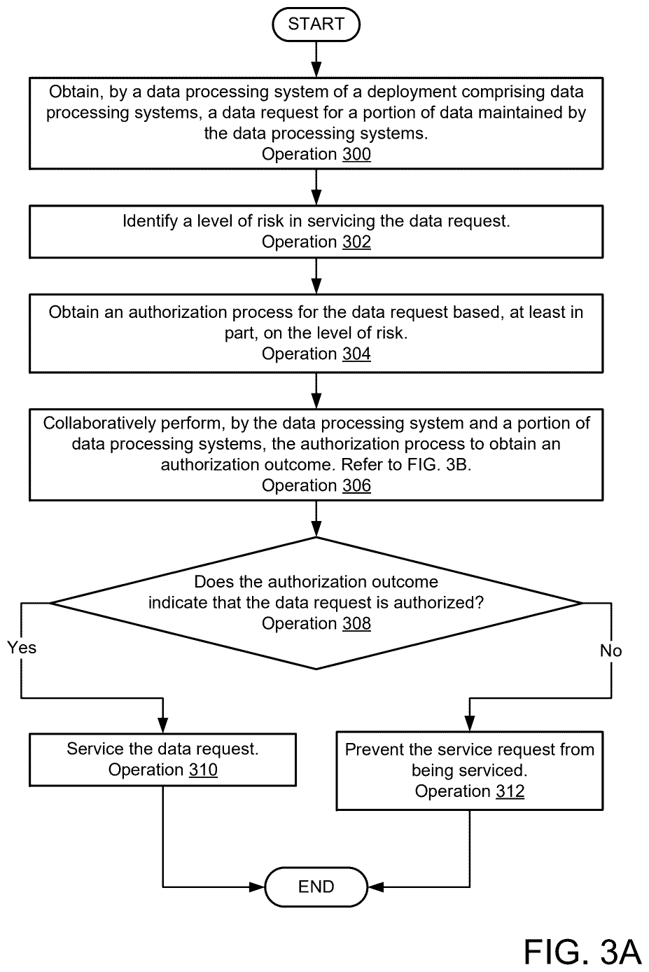

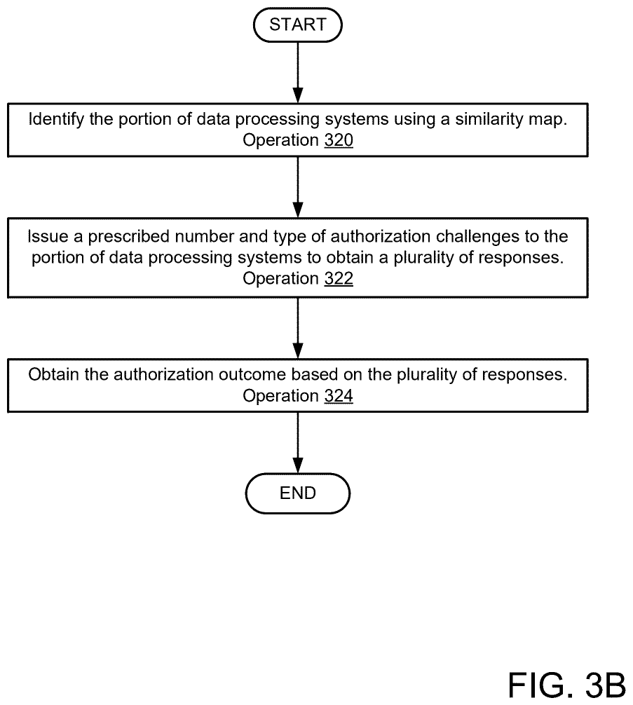

While providing their functionality, any of data processing systems 100 and/or management system 102 may provide all or a portion of the methods shown in FIGS. 2A-3B.

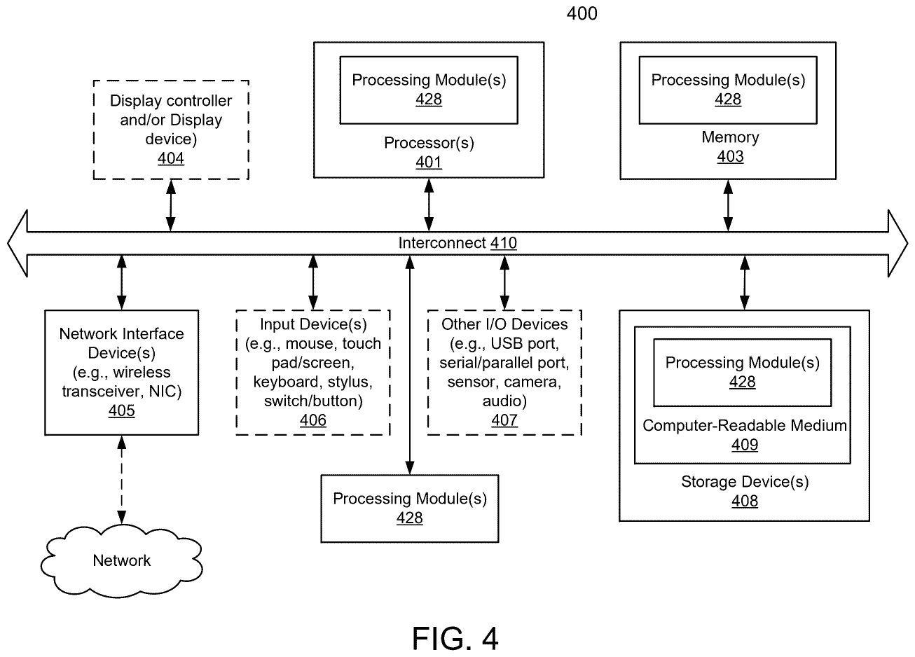

Communication system 104 may allow any of data processing systems 100, and management system 102 to communicate with one another (and/or with other devices not illustrated in FIG. 1). To provide its functionality, communication system 104 may be implemented with one or more wired and/or wireless networks. Any of these networks may be a private network (e.g., the “Network” shown in FIG. 4), a public network, and/or may include the Internet. For example, data processing systems 100 may be operably connected to management system 102 via the Internet. Data processing systems 100, management system 102, and/or communication system 104 may be adapted to perform one or more protocols for communicating via communication system 104.

Any of (and/or components thereof) data processing systems 100, and management system 102 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

Thus, as shown in FIG. 1, a system in accordance with an embodiment may manage operation of a deployment comprising data processing systems. By collaboratively performing an authorization process based on a level of risk identified for a data request, risk may be mitigated while providing computer-implemented services based on the data request.

While illustrated in FIG. 1 with a limited number of specific components, a system may include additional, fewer, and/or different components without departing from embodiments disclosed herein.

To further clarify embodiments disclosed herein, a data flow diagram in accordance with an embodiment are shown in FIG. 2A. In the diagram, a flow of data and processing of data are illustrated using different sets of shapes. A first set of shapes (e.g., 200, 204, etc.) is used to represent data structures, a second set of shapes (e.g., 202, 206, etc.) is used to represent processes performed using and/or that generate data, and a third set of shapes (e.g., 210, 214, etc.) is used to represent large scale data structures such as databases.

Turning to FIG. 2A, a data flow diagram in accordance with an embodiment is shown. The first data flow diagram may illustrate data used in and data processing performed in collaboratively authorizing a data request to be serviced.

Data request 200 may be obtained by a data processing system (e.g., 100A of a deployment of data processing systems 100. Data request 200 may be sent from an entity (e.g., a user of a data processing system, a software agent hosted by a data processing system, etc.) attempting to access (e.g., read, delete, overwrite, etc.) a portion of data maintained by data processing systems 100 to access (e.g., read, delete, overwrite, etc.) a portion of data maintained by data processing systems 100. In addition to data specifications (e.g., type of data, data source, operation to be performed for the data, etc.), data request 200 may include information relevant to the entity. For example, data request 200 may include an internet protocol address, a geographic location of the entity, a connection type used to transit the data request to data processing system 100A, an origination time of the data request, profile of activity of the entity in generating the data request, and/or any other information. Because data request 200 may be sent by a malicious entity, attempt to use the data for malicious purposes, and/or otherwise negatively impact computer-implemented services provided by data processing systems 100, data request 200 may be analyzed for authorization prior to being serviced by data processing systems 100.

To identify a level of autonomy ascribed to data processing system 100 with respect to servicing data request 200, autonomy analysis process 202 may be performed. During autonomy analysis process 202, a magnitude (e.g., high, low, moderate, etc.) of servicing data request 200 may be assessed. For example, to assess the magnitude of servicing data request 200, data processing system 100 may (i) identify an impact of servicing the data request (e.g., via a simulation, using an impact model, etc.), (ii) ingest the impact in an autonomy model to obtain an autonomy level outcome, and/or perform any other actions. By doing so, data processing system 100A may be guided to select, using a similarity map from similarity map repository 214, at least one other data processing system (e.g., 100B, etc.) based on a measure of similarity between data processing system 100A and the at least one other data processing system.

Autonomy level outcome 204 may include the level of the autonomy that can be identified by granting, by an autonomy model, a measure of discretion to the data processing system (e.g., 100A) in a performing an operation to authorize and/or service data request 200. The measure of discretion may indicate a less autonomous (e.g., command-driven), a partially autonomous (e.g., consensus-based), a more autonomous (e.g., self-directed), etc. performance of the operation by the data processing system 100A. With the measure of the discretion, data processing system 100A may be directed may collaborate with at least one other data processing system (e.g., 100B, etc.) of the deployment.

For example, if autonomy level outcome 204 indicates data processing system has a lower level of autonomy, data processing system 100A may be directed to select a larger quantity of data processing systems with which to collaborate. that is determined to have a low impact level, the data processing system 100A may be enabled to select the at least one other data processing system that is mostly similar to the data processing system 100A (e.g., based on similarity rankings indicated by a similarity map). However, if data request is determined to have a high impact level, data processing system 100A may be directed to select the at least one other data processing system that is similar and/or dissimilar to the data processing system (e.g., 100).

To identify a level of risk in servicing data request 200, risk analysis process 206 may be performed. During risk analysis process 206, information regarding the entity may be analyzed, and a risk level outcome (e.g., 208) may be obtained. For example, the information regarding the entity may be analyzed by (i) obtaining historic information regarding previously issued data requests by the entity, (ii) performing pattern matching to identify whether data request 200 may be unusual compared to the historic information, (iii) computing a level of difference between data request 200 and the historic information, and/or any other processes. Based on at least the level of difference, risk level outcome 208 may be established. For example, the level of difference may indicate a likelihood that data request 200 may negatively impact at least a portion of data processing systems 100.

Risk level outcome 208 may include any number and/or type of information regarding a level of risk in servicing a data request (e.g., 200) by data processing system 100. Risk level outcome 208 may be obtained, for example, by multiplying a likelihood of a negative impact (e.g., based on the level of difference) by a magnitude of the negative impact (e.g., a quantity of data processing systems that may be impacted, an estimated downtime to resolve a potential issue associated with the negative impact, etc.). Risk level outcome 208 may be used in identifying an authorization process to be performed for data request 200.

To obtain an authorization outcome regarding whether data request 200 may be serviced, request authorization process 212 may be performed. During request authorization process 212, an authorization process may be identified based on the level of risk, a portion of data processing systems 100 with which to collaborate may be identified, and the identified authorization process may be collaboratively performed with the identified portion of data processing systems 100. For example, to identify the authorization process, policy repository 210 may be searched using risk level outcome 208 as a key. Policy repository 210 may include any number and/or type or information regarding authorization processes to be performed. The authorization processes may be defined, for example, by an entity tasked with managing security policies for data processing systems 100. Each authorization policy may specify a minimum set of authorization mechanisms to be used in authorizing of data requests. For example, the authorization mechanism may include credentials (e.g., username, password, etc.) of a user that originated the data request, an attestation for the entity (e.g., a digital token, certificate, hardware-based cryptographic proof, etc.), a third-party verification for the entity, and/or any other authorization mechanisms.

The portion of data processing systems 100 with which data processing system 100 may collaborate to obtain an authorization outcome may be selected based on autonomy level outcome 204 and using a similarity map obtained from similarity map repository 214. The similarity map may provide information regarding levels of similarity between the data processing systems, identification information for the data processing systems, and/or any other information. As previously discussed, autonomy level outcome 204 may indicate, for example, a number of data processing systems and/or level of similarity for each of the data processing systems.

As such, data processing system 100 may collaboratively perform the authorization process by communicating with the identified portion of data processing systems 100 to provide authorization information, the information regarding the entity and/or the data request, issue prescribed authorization challenges indicated by the minimum set of authorization mechanisms, and/or any other information. In response, data processing system 100 may obtain a collaborative decision based on a plurality of responses from the portion of data processing systems 100. The plurality of responses may include, for example, requested information to satisfy the authorization challenges (e.g., credentials, certificates, vouchers, etc.) as well as a decision regarding whether data request 200 is authorized to be serviced. Any of the portion of data processing systems 100 may provide enhanced information regarding a risk of servicing data request 200 based on similarity and/or dissimilarity to data processing system 100 and evaluation of the information regarding the entity. By performing the request authorization process 212, data processing system 100 may obtain an authorization outcome (e.g., 216) that may indicate whether data request 200 is authorized to be serviced, additional authorization challenges to be issued to the entity, and/or any other information.

To perform an operation based on the data request and/or the authorization outcome 216, request servicing process 218 may be performed. In a first instance where authorization outcome 216 indicates that data request 200 is authorized, data processing system 100A may service the data request to facilitate provisioning of desired computer-implemented services. For example, data processing system 100A may transmit a copy of a requested portion of data hosted by data processing systems 100A, perform a requested operation using the requested portion of data (e.g., deletion of the requested portion of data, modification of the requested portion of data, etc.), provide at least temporary access to data storage to the entity, require additional credentials from the entity, and/or perform any other actions. Additionally, in a second instance where authorization outcome 216 indicates that data request 200 is not authorized to be serviced, data processing system 100A may prevent the entity from accessing the data, blocking communications from the entity, and/or performing any other actions to prevent unauthorized access to the data by the entity.

Thus, using the data flow shown in FIG. 2A, a data request for a portion of data maintained by data processing systems may be collaboratively authorized based on an assessed level of risk associated with servicing the data request. By doing so, a risk that the data request may negatively impact the data processing systems may be mitigated.

To further clarify embodiments disclosed herein, interactions diagrams in accordance with an embodiment are shown in FIGS. 2B-2C. These interactions diagrams may illustrate how data may be obtained and used within the system of FIG. 1.

In the interaction diagrams, processes performed by and interactions between components of a system in accordance with an embodiment are shown. In the diagrams, components of the system are illustrated using a first set of shapes (e.g., 100, 100B, etc.), located towards the top of each figure. Lines descend from these shapes. Processes performed by the components of the system are illustrated using a second set of shapes (e.g., 262, 272, etc.) superimposed over these lines. Interactions (e.g., communication, data transmissions, etc.) between the components of the system are illustrated using a third set of shapes (e.g., 264, 266, etc.) that extend between the lines. The third set of shapes may include lines terminating in one or two arrows. Lines terminating in a single arrow may indicate that one way interactions (e.g., data transmission from a first component to a second component) occur, while lines terminating in two arrows may indicate that multi-way interactions (e.g., data transmission between two components) occur.

Generally, the processes and interactions are temporally ordered in an example order, with time increasing from the top to the bottom of each page. For example, the interaction labeled as 264 may occur prior to the interaction labeled as 266. However, it will be appreciated that the processes and interactions may be performed in different orders, any may be omitted, and other processes or interactions may be performed without departing from embodiments disclosed herein.

Turning to FIG. 2B, a first interaction diagram in accordance with an embodiment is shown. The first interaction diagram may illustrate data used in and data processing performed in collaborating, by two data processing systems (e.g., 100A, 100B, etc.), to authorize a low risk request (e.g., 268).

To authorize the low risk request (e.g., 268), authorization process 262 may be performed. During authorization process 262, at least one authorization challenge prescribed by an identified authorization process be issued by a first data processing system (e.g., 100A) to a second data processing system (e.g., 100B). The at least one authorization challenge may be issued to data processing system 100B in authorizing the low risk request because low request 268 may have a lower likelihood of impacting a higher number of data processing systems.

An assignment of the first data processing system (e.g., 100A) and/or the second data processing system (e.g., 100B) may be performed using a similarity map and/or at least one autonomy model. According to the similarity map, the first data processing system (e.g., 100A) may have first attributes that may be similar to second attributes of the second data processing system (e.g., 100B). As a result of the similarity between the first attributes and the second attributes, the at least one autonomy model may direct the first data processing system (e.g., 100A) to collaborate with the second data processing system (e.g., 100B). Therefore, using the first attributes of the first data processing system (e.g., 100A) and the second attributes of the second data processing system (e.g., 100B), each data processing system may (i) learn a less diverse approach to identifying risk, (ii) utilize similar resources to perform an operation to authorize the request, etc.

At interaction 264, a request for a response to the at least one authorization challenge may be provided to data processing system 100B by data processing system 100A. The request may include information regarding low risk request 268, an entity that sent low risk request 268, a request for information to satisfy the at least one authorization challenge, etc.

At interaction 266, a response may be provided to data processing system 100A from data processing system 100B. For example, the response may include credentials of data processing system 100B, a decision regarding whether low risk request 268 is authorized based on evaluation by data processing system 100B, and/or any other information.

Thus, via the first interaction illustrated in FIG. 2B, a system in accordance with an embodiment may collaborate, by two data processing systems (e.g., 100A, 100B, etc.), to authorize the low risk request (e.g., 268). Consequently, the data processing system may be more likely to be able to provide desired computer-implemented services by leveraging combined computational resources of a few data processing systems (e.g., 100A, 100B, etc.) with similar attributes.

Turning to FIG. 2C, a second interaction diagram in accordance with an embodiment is shown. The second interaction diagram may illustrate data used in and data processing performed in collaborating, by three data processing systems (e.g., 100A, 100B, 100C etc.), to authorize a high risk request (e.g., 270).

High risk request (e.g., 270) may include for example a request to delete a shared database hosted by and/or maintained by a large portion (e.g., 50 percent) of data processing systems 100. Because the magnitude of the risk is higher based on the large portion of data processing systems 100 that may be negatively impacted and/or the extent of the risk is higher based on the requested operation, additional data processing systems may be assigned to assess the risk and subsequently authorize the data request with respect to servicing.

To authorize the high risk request (e.g., 270), authorization process 272 may be performed. During authorization process 272, at least one authorization challenge prescribed by an identified authorization process be issued by a first data processing system (e.g., 100A) to a second data processing system (e.g., 100B) and a third data processing system (e.g., 100C). The at least one authorization challenge may be issued to data processing system 100B and data processing system 100C in authorizing the high risk request because high request 270 may have a higher likelihood of impacting a higher number of data processing systems. Additionally, the at least one authorization challenge may be different (e.g., more complex) and/or have a higher quantity than the at least one authorization challenge issued in FIG. 2B (e.g., for a low risk request).

An assignment of the second data processing system (e.g., 100B) and/or the third data processing system (e.g., 100C) may similarly be performed using a similarity map and/or at least one autonomy model. According to the similarity map, the first data processing system (e.g., 100A) may have first attributes that may be similar to second attributes of the second data processing system (e.g., 100B) and/or third attributes of the third data processing system (e.g., 100C). As a result of the similarity between the first attributes, the second attributes and the third attributer, the at least one autonomy model may direct the first data processing system (e.g., 100A) to collaborate with the second data processing system (e.g., 100B) and the third data processing system (e.g., 100C).

At interaction 274, a request for a response to the at least one authorization challenge may be provided to data processing system 100B by data processing system 100A. The request may include information regarding high risk request 270 an entity that sent high risk request 270, a request for information to satisfy the at least one authorization challenge, etc.

At interaction 276, a response may be provided to data processing system 100A from data processing system 100B. For example, the response may include credentials of data processing system 100B, a decision regarding whether high risk request 270 is authorized based on evaluation by data processing system 100B, and/or any other information.

At interaction 290, a request for a response to the at least one authorization challenge may be provided to data processing system 100C by data processing system 100A. The request may similarly include information regarding high risk request 270 an entity that sent high risk request 270, a request for information to satisfy the at least one authorization challenge, etc.

At interaction 292, a response may be provided to data processing system 100A from data processing system 100C. For example, the response may include credentials of data processing system 100C, a decision (e.g., that may be similar or dissimilar to a decision provided by data processing system 100B) regarding whether high risk request 270 is authorized based on evaluation by data processing system 100C, and/or any other information.

By doing so, data processing system 100A may aggregate responses obtained from data processing system 100B and data processing system 100C based on a level of autonomy. For example, the responses may be aggregated to reach a consensus, to vote on an authorization outcome, and/or any other methods.

Thus, via the second interaction illustrated in FIG. 2C, a system in accordance with an embodiment may collaborate, by the three data processing systems (e.g., 100A, 100B, 100C, etc.), to authorize the high risk request (e.g., 270). Consequently, the data processing systems may be more likely to be able to provide desired computer implemented services by leveraging combined computational resources of more data processing systems.

Any of the processes illustrated using the second set of shapes and interactions illustrated using the third set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes and interactions illustrated using the third set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the processes and interactions may be implemented using any type and number of data structures. The data structures may be implemented using, for example, tables, lists, linked lists, unstructured data, data bases, and/or other types of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

As discussed above, the components of FIG. 1 may perform various methods to manage data processing systems. FIGS. 3A-3B illustrate methods that may be performed by the components of the system of FIG. 1. In the diagrams discussed below and shown in FIGS. 3A-3B, any of the operations may be repeated, performed in different orders, and/or performed in parallel with or in a partially overlapping in time manner with other operations.

Turning to FIG. 3A, a flow diagram illustrating a method of managing operation of a deployment comprising data processing systems in accordance with an embodiment is shown. The method may be performed, for example, by any of the components of the system of FIG. 1, and/or other components not shown therein.

At operation 300, a data request may be obtained for a portion of data maintained by data processing systems. The data request may be obtained by: (i) receiving the data request via transmission of a message from an entity requesting access for the portion of the data, (ii) receiving the data request via an application programming interface call to share data, (iii) obtaining the data request using a software agent hosted by the data processing system, and/or any other processes.

At operation 302, a level of risk may be identified in servicing the data request. The level of risk may be identified by: (i) performing pattern matching to identify whether the data request deviates from historic information regarding previous data requests issued by the entity, (ii) simulating an impact of servicing the data request, (iii) prompting a large language model to identify the level of risk based on information regarding the entity and/or the requested data, (iv) computing a likelihood that the entity may be malicious based on a profile of activity of the entity, (v) verifying privileges granted to the entity, and/or performing any other actions.

At operation 304, an authorization process may be obtained for the data request based, at least in part on the level of risk. The authorization process may be obtained by: (i) querying a repository (e.g., a database, a registry, etc.) using a level of risk and/or information regarding the data processing system as a key to obtain a result, (ii) using a policy engine to select a predefined authorization process configured in a policy store, and/or any other processes.

At operation 306, the authorization process may be collaboratively performed to obtain an authorization outcome. The authorization process may be collaboratively performed by: (i) selecting a portion of data processing systems with which to collaborate using a similarity map, (ii) issuing a prescribed number and type of authorization challenges to the portion of data processing systems to obtain a plurality of responses, (iii) obtaining an authorization outcome bases on the responses, and/or any other processes. Refer to FIG. 3B for additional details regarding performing the authorization process.

At operation 308, a determination may be made regarding whether the authorization outcome indicates that the data request is authorized. The determination may be made by: (i) aggregating responses from the portion of data processing systems to reach a consensus regarding authorization of the data request, (ii) comparing the authorization outcome to a threshold, (iii) verifying an authorization status code indicated by the authorization outcome, and/or performing any other actions. If the authorization outcome indicates that the data request is authorized (e.g., the determination is “Yes” at operation 308), then the method may proceed to operation 310. If the authorization outcome indicates that the data request is not authorized (e.g., the determination is “No” at operation 308), then the method may proceed to operation 312.

At operation 310, the data request may be serviced to facilitate provisioning of computer-implemented services. The data request may be serviced by: (i) transmitting a copy of the requested portion of data to the entity, (ii) granting permission to the entity for accessing the portion of data, (iii) performing a requested operation (e.g., modification, creation, deletion, etc.) on the portion of the data, and/or performing any other actions.

The method may end following operation 310.

Returning to operation 308, the method may proceed to operation 312 following operation 308 when the authorization outcome indicates that the data request is not authorized.

At operation 312, the service request may be prevented from being serviced. The service request may be prevented from being serviced by: (i) denying access to the data, (ii) transmitting a error status code to the entity regarding the data request, (iii) placing the entity on a blacklist with regard to accessing the portion of data, (iv) masking the data, and/or any other processes.

The method may end following operation 312.

Using the method shown in FIG. 3A, operation of data processing systems in a deployment may be managed by collaboratively performing an authorization process to authorize a data request for a portion of data maintained by the data processing systems. By using the level of risk identified in servicing the data request, a risk of servicing a data request that may negatively impact the data processing systems may be reduced.

Turning to FIG. 3B, a second flow diagram illustrating a method of collaboratively performing an authorization process in accordance with an embodiment is shown. The method may be performed, for example, by any of the components of the system of FIG. 1, and/or other components not shown therein.

At operation 320, a portion of data processing systems may be identified using a similarity map. The portion of data processing systems may be identified by: (i) performing a similarity search using a copy of the similarity map, (ii) identifying neighboring nodes in the similarity map based on labeled clusters of nodes, (iii) prompting a large language model based on the similarity map to identify the portion of data processing systems that may be most suitable with which to collaborate, and/or via any other processes.

At operation 322, a prescribed number and type of authorization challenges may be issues to the portion of data processing systems. The prescribed authorization challenges may be issued by: (i) prompting the portion of data processing systems to provide credentials (e.g., username, password, etc.), (ii) submitting a request for a valid digital signature to establish trust, (iii) passing a token in a request header, (iv) invoking a multi-factor authentication mechanism (e.g., one-time password), and/or performing any other actions.

At operation 324, an authorization outcome may be obtained based on the plurality of responses. The authorization outcome may be obtained by: (i) validated requested credentials from the portion of data processing systems, (ii) applying a consensus algorithm (e.g., Paxos, Byzantine Fault Tolerance, etc.) to agree on a single course of action, (iii) voting (e.g., simple majority, weighted voting) on an authorization status, and/or any other processes.

The method may end following operation 324.

Using the method shown in FIG. 3B, a data processing system may collaborate with other data processing systems to obtain an authorization outcome regarding a data request from an entity. By doing so, the authorization outcome may be based on more diverse and/or enhanced information compared to authorization by one data processing system.

Any of the components illustrated in FIGS. 1-2C may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing operation of a deployment comprising data processing systems, the method comprising:
obtaining, by a data processing system of the data processing systems, a data request for a portion of data maintained by the data processing systems;
identifying, by the data processing system, a level of risk in servicing the data request based on, at least in part, information regarding an entity that originated the data request;
obtaining, by the data processing system, an authorization process for the data request based, at least in part, on the level of risk;
collaboratively performing, by the data processing system and a portion of the data processing systems, the authorization process to obtain an authorization outcome; and
in a first instance of the collaborative performing where the authorization outcome indicates that the data request is authorized:
servicing, by the data processing system, the data request to facilitate provisioning of desired computer implemented services.

2. The method of claim 1, wherein identifying the level of risk comprises:
obtaining at least one portion of information from a list of information consisting of:
an internet protocol address of the entity;
a geographic location of the entity;
a connection type used to transit the data request to the data processing system;
an origination time of the data request; and
a profile of activity of the entity in generating the data request.

3. The method of claim 2, wherein identifying the level of risk further comprises:
comparing the at least the one portion of the information to historic information regarding previously issued data requests by the entity to identify a level of difference; and
establishing the level of risk based on, at least, the level of difference.

4. The method of claim 1, wherein obtaining the authorization process comprises:
searching a repository of authorization processes using the level of risk as a key to identify the authorization process.

5. The method of claim 4, wherein the repository comprises a plurality of authorization processes that are each keyed to different levels of risk.

6. The method of claim 5, wherein each authorization process of the plurality of authorization processes specifies a minimum set of authorization mechanisms to be used in authorizing of data requests, and the minimum set of authorization mechanisms increase as the level of risk increases.

7. The method of claim 6, wherein the authorization mechanisms comprise at least one selected from a list of authorization mechanisms consisting of:
credentials of a user that originated the data request;
an attestation for the entity; and
a third party verification for the entity.

8. The method of claim 1, wherein collaboratively performing the authorization process comprises:
identifying the portion of the data processing systems using a similarity map;
issuing a prescribed number and type of authorization challenges to the portion of the data processing systems to obtain a plurality of responses; and
obtaining the authorization outcome based on the plurality of responses.

9. The method of claim 8, wherein the similarity map quantifies levels of similarity between the data processing systems, and the portion of the data processing systems is discriminated from the data processing systems based on the levels of similarity.

10. The method of claim 9, wherein the levels of similarity are used to rank order the data processing systems, and the portion of the data processing systems is selected based on the rank ordering of the data processing systems.

11. The method of claim 8, wherein collaboratively performing the authorization process further comprises:
identifying a level of autonomy for selection of a manner in which to perform the authorization process based on an estimated impact level of the data request.

12. The method of claim 11, wherein the level of autonomy is identified using an autonomy model that vests more decision power in the data processing system as the estimated impact level is reduced and vests less decision power in the data processing system as the estimated impact level is increased.

13. A non-transitory machine-readable medium having instructions stored therein, which when executed by a processor, cause the processor to perform operations for managing operation of a deployment comprising data processing systems, the operations comprising:
obtaining, by a data processing system of the data processing systems, a data request for a portion of data maintained by the data processing systems;
identifying, by the data processing system, a level of risk in servicing the data request based on, at least in part, information regarding an entity that originated the data request;
obtaining, by the data processing system, an authorization process for the data request based, at least in part, on the level of risk;
collaboratively performing, by the data processing system and a portion of the data processing systems, the authorization process to obtain an authorization outcome; and
in a first instance of the collaborative performing where the authorization outcome indicates that the data request is authorized:
servicing, by the data processing system, the data request to facilitate provisioning of desired computer implemented services.

14. The non-transitory machine-readable medium of claim 13, wherein identifying the level of risk comprises:
obtaining at least one portion of information from a list of information consisting of:
an internet protocol address of the entity;
a geographic location of the entity;
a connection type used to transit the data request to the data processing system;
an origination time of the data request; and
a profile of activity of the entity in generating the data request.

15. The non-transitory machine-readable medium of claim 14, wherein identifying the level of risk further comprises:
comparing the at least the one portion of the information to historic information regarding previously issued data requests by the entity to identify a level of difference; and
establishing the level of risk based on, at least, the level of difference.

16. The non-transitory machine-readable medium of claim 13, wherein obtaining the authorization process comprises:
searching a repository of authorization processes using the level of risk as a key to identify the authorization process.

17. A system, comprising:
a processor; and
a memory coupled to the processor to store instructions, which when executed by the processor, cause the processor to perform operations for managing operation of a deployment comprising data processing systems, the operations comprising:
obtaining, by a data processing system of the data processing systems, a data request for a portion of data maintained by the data processing systems;
identifying, by the data processing system, a level of risk in servicing the data request based on, at least in part, information regarding an entity that originated the data request;
obtaining, by the data processing system, an authorization process for the data request based, at least in part, on the level of risk;
collaboratively performing, by the data processing system and a portion of the data processing systems, the authorization process to obtain an authorization outcome; and
in a first instance of the collaborative performing where the authorization outcome indicates that the data request is authorized:
servicing, by the data processing system, the data request to facilitate provisioning of desired computer implemented services.

18. The system of claim 17, wherein identifying the level of risk comprises:
obtaining at least one portion of information from a list of information consisting of:
an internet protocol address of the entity;
a geographic location of the entity;
a connection type used to transit the data request to the data processing system;
an origination time of the data request; and
a profile of activity of the entity in generating the data request.

19. The system of claim 18, wherein identifying the level of risk further comprises:
comparing the at least the one portion of the information to historic information regarding previously issued data requests by the entity to identify a level of difference; and
establishing the level of risk based on, at least, the level of difference.

20. The system of claim 17, wherein obtaining the authorization process comprises:
searching a repository of authorization processes using the level of risk as a key to identify the authorization process.
